(19) United States
(12) Patent Application Publication
(10) Pub. No.: US 2003/0217159 A1
(43) Pub. Date: Nov. 20, 2003

(54) Apparatus and method for sharing session information

(75) Inventors: Susan Schramm-Apple, Hatfield, PA (US); Sean Dippold, Schwenksville, PA (US); Melanie Kittrell, Maple Glen, PA (US); Keith Bauer, Souderton, PA (US); Lori Moore, Lafayette Hill, PA (US)

Correspondence Address: HALE & DORR LLP, THE WILLARD OFFICE BUILDING, 1455 PENNSYLVANIA AVE, NW, WASHINGTON, DC, 20004, US

(73) Assignee: Merck & Co., Inc., Rahway, NJ

(21) Appl. No.: 10/390,168

(22) Filed: Mar. 18, 2003

Related U.S. Application Data
(60) Provisional application No. 60/364,743, filed on Mar. 18, 2002.

(51) Int. Cl. G06F 15/16

(52) U.S. Cl. 709/228; 709/229

(57) ABSTRACT

A system and method are disclosed for sharing session information. The system comprises a database system, a first computer system capable of accessing the database system, and a second computer system also capable of accessing the database system. A user accesses a first website hosted by the first computer system, and a session is initialized for the user. A profile object is created for the user and serialized. The serialized profile object is subsequently stored in the database system with a key. The second computer system queries the database system in order to retrieve the serialized profile object matching the key. The second computer deserializes the profile object and restores the session at the second website together with shared session information.

### CROSS-REFERENCE TO RELATED APPLICATIONS

This application claims priority to U.S. Provisional Patent Application No. 60/364,743, entitled “Computer Implemented and/or Assisted Process and System for MerckMedicus” filed Mar. 18, 2002, the entire contents of which are hereby incorporated by reference.

This application is related to the following U.S. Patent applications: Attorney docket numbers 105456.121, 105456.123, 105456.125, 105456.126, and 105456.127, to the same inventors, and all of which are incorporated herein by reference.

### BACKGROUND OF THE INVENTION

1. Technical Field

The present invention relates to electronic medical research information systems and, more particularly, to a system and method for sharing user information between different electronic medical research computer systems and database systems.

2. Description of the Related Art

In the healthcare field, healthcare professionals often obtain information from medical publishers, with most of this information being just in print. Academic institutions have considerable resources which are available in libraries, that unfortunately are not universally available to physicians. Hence, paper resources with healthcare information can be difficult to access.

In an attempt to provide information electronically, early websites were sponsored by a variety of commercial entities, academic institutions, or medical associations. There was, nevertheless, a lack of awareness among physicians of the World Wide Web (www or the web) as a resource for obtaining information and/or other materials needed by physicians. Premium resources were sometimes provided on these websites, although there was limited exposure and/or access by physicians and other healthcare professionals.

These conventional means of providing information and other healthcare professional resources resulted in an uneven playing field for healthcare providers. In addition, there were a number of other hurdles facing office-based, rural and non-institutional healthcare professionals. Physicians and other healthcare providers have adapted to the current situation. Although there is a much greater degree of information available, oftentimes it does not find its way into the hands of physicians and healthcare providers, and ultimately does not result in improved healthcare. Nevertheless, the ability to save time and/or money is one of the primary motivators for physicians or healthcare professionals to change their habits.

The information and/or information gathering process has conventionally been difficult and awkward for healthcare providers. The information not provided in one convenient place. Moreover, the information itself be inconvenient. For example, if the information is provided by subscription, it is typically expensive to obtain multiple subscriptions. On the other hand information in textbooks might not be up-to-date. Further, textbooks, journals and libraries are not well suited to physicians' nomadic working style, which typically includes travel between an office and a hospital. Information which might be provided over the web may be jumbled or confused, with multiple locations, passwords, formats, browsers and search engines provided for a variety of information. Ultimately, physicians and other providers have entirely too many subscriptions, accounts, ID's and passwords, making the information retrieval process awkward.

With regard to utilizing the Internet, the physicians might question the quality of information or services provided online. Moreover, such information and services might be biased, for example as a result of a sponsor of a particular product, unbeknownst to the users. Where information in websites is searchable, the search engines that are provided might not retrieve results that are most relevant to the physicians' query.

In certain situations, access to information or services might be tied to a specific license or specialized technology. For example, in order to obtain certain information or services, the physician might be required to use a specific computer or install certain technology. In addition, sites that are provided by pharmaceutical companies tend not to focus on physicians. These sites are product driven and patient oriented. They fail to address for the needs of the physician as a customer. In short, it is difficult to obtain information or services via conventional methods.

One specific example of a website directed to physicians is Medscape/WebMD. Unbeknownst to physicians, however, Medscape/WebMD is commercially sponsored and exhibits a bias. As another example, this site gives physicians limited access to premium resources, such as the best journals and text, because there is no financial incentive to make this information available. Moreover, typical of these types of sites, Medscape/WebMD does not have access to the premium resources sufficient to place them online.

Meanwhile, physicians are facing an increasing number of pressures. These pressures on healthcare practitioners include an increase in time perhaps caused by busy practices and overwhelming paperwork. At the same time, healthcare practitioners face decreasing practice revenues. They also face information overload, with a decreasing amount of time to sort through relevant information.

The inventors have determined that physicians and/or other healthcare professionals engage in a number of online activities, including literature searches, reading medical news in the professional press, reading professional journals, finding patient educational materials, using drug reference databases, researching upcoming meetings, engaging in online continuing medical education (CE), reading medical news in the lay press, communicating with colleagues, finding out about clinical trials, learning about medical devices, reading medical text, and/or participating in MD chat rooms. It is estimated, by the inventors, that online CE is engaged in by 58% and 51% of primary care providers and physician specialists, respectively, engage in online CE.

The inventors have determined that physicians refer to medical information sites primarily to obtain news and reference materials. In one study by the inventors, in responding to a question about the three most important factors a physician uses in determining which medical information sites to use, the following responses were provided:

| Description | Percent |
|---|---|
| Medline Literature Search | 64% |
| Medical News Updates and Alerts | 53% |
| Medical Journals | 47% |
| Drug Reference Database | 34% |
| Medical Textbooks | 30% |
| Continuing Education Online Courses | 29% |
| Patient Relationship Information and Guides | 20% |
| Clinical Trial Information and Links | 15% |
| Listing of Medical Organizations and Meetings | 7% |
| Financial and World News | 5% |
| Community and Messages Boards | 4% |

The inventors performed extensive research with physicians regarding website features and functionality, including advisory boards, one-on-ones and online user ability testing. The above table highlights the findings of the online usability test of 154 physician respondents.

According to the Online Physician Market Dynamics Study (ZIMENT), February/March 2001, (Q9), quality, credibility and ease of use are the most important features to physicians in an online service. The following are attributes that are important to specialists and primary care physicians:

Provides credible information

Provides quality information

Is easy to use*

Provides up-to-date health and medical information*

Enables effective research of usual cases or conditions

Is comprehensive

Offers premium medical resources not easily accessible elsewhere

Helps physicians communicate better with patients

Is available to doctors only and not general consumers

Offers ability to customize site based on preferences or specialty

Has a professional look and feel

Is unique from other sites (* These attributes are less important to specialists than primary care physicians.)

Current attempts at providing electronic information has failed to meet the needs of today's medical community. For example, we have determined that physicians and healthcare professionals would prefer a website with cutting edge tools and resources, available in a single portal, as a key to the medical Internet. We have determined that physicians and other healthcare providers would prefer that such a site is ethical, credible, insightful, unbranded and objective. We have further determined that such a site should be for physicians and healthcare professionals, and provide access to premium medical resources.

In situations where premium information has been made available to healthcare providers, the actual content is stored at a different location from the website being accessed, or subscribed to be the healthcare provider. For example, the healthcare provider may be presented a web page which includes a link to a premium database. When the healthcare provider attempts to access the database, they are redirected to a new website where the actual content is stored. In order to access the new website, however, the healthcare provider is often prompted to input new authentication information such as a username/password combination. Healthcare providers are often discouraged by the number of accounts which they must maintain. Additionally, the requirement of authentication at every premium website discourages healthcare providers from even attempting to use websites that provide premium content.

Accordingly, there exists a need for as system capable of providing extensive information to physicians and healthcare providers electronically.

There also exists a need for a system which allows physicians and healthcare providers to easily and conveniently access premium content stored in external websites.

There exists a further need for a system which does not require authentication each time premium content from an external website must be accessed.

### SUMMARY OF THE INVENTION

It is therefore one feature and advantage of the present invention to address at least some of the shortcomings of the prior art in providing electronic information to physicians and healthcare providers.

It is another optional feature and advantage of the present invention to provide a system containing extensive information which may be accessed by physicians and/or healthcare providers electronically.

It is yet another optional feature and advantage of the present invention to provide a system which allows physicians and healthcare providers convenient access to premium content stored on external websites.

It is a further optional feature and/or advantage of the present invention to provide a system which does not require authentication from a user each time premium content from an external website must be accessed.

The foregoing, and various other needs, are addressed, at least in part, by the present invention, wherein a user's authentication information is serialized and used to provide access at a different website without the need for re-authentication.

According to one embodiment of the invention, a method for sharing session information comprises: serializing a session; generating a key associated with the serialized session; storing the serialized session and the associated key into a database system; transmitting the key to a destination where the session information will be shared; and restoring the session including the shared session information at the destination based, at least in part, on the transmitted key.

Optional aspects and/or embodiments of the present invention further provide for receiving information from a user in order to establish the session. The information is then authenticated to ensure that the user should be granted access. Another optional aspect of the present invention specifically requires the user input a user ID and password. If a user ID and password are not available, the user can be given an option to create them. Another optional embodiment of the present invention requires that the destination be a website which is unrelated to the first website. Additionally the second website must extract, or deserialize, the serialized session from the database in order to restore the session.

According to another optional embodiment of the present invention, a method for sharing session information comprises: accessing a first website by a user; serializing a profile object for the user; storing the serialized profile object in a database system with a key; forwarding the key to a second website where the session information will be shared; deserializing the profile object based, at least in part, on the key; and restoring the session at the second website together with the shared session information.

Optional aspects of the invention require that a profile object be created for users who select a link which identifies information stored on the second website. Additionally, the key can be generated by and transmitted to the first website from the database system, and the user is redirected to the second website. At the second website, a new session can be created for the user and a request sent to the database system for a serialized profile object matching the key. If a match exists, the database system returns the serialized profile object. The second website deserializes the profile object into the new session, and displays the web page associated with the link selected by the user.

According to another embodiment of the present invention, a method for sharing session information comprises: initializing a session at a first website; selecting a link which identifies information stored on a second website; serializing the session at the first website; generating a key associated with the serialized session; storing the serialized session and associated key into a database system; sending the key to the second website where the session information will be shared; extracting the serialized session from the database system using the received key; and restoring the session at the second website together with the shared session information.

All of the methods described herein may be performed sequentially, non-sequentially and/or sequence-independent, and/or any combination of steps described herein.

Another aspect of the present invention provides a system for sharing session information. The system comprises a database system coupled to an electronic network, a first computer system coupled to the electronic network and capable of accessing the database system, and a second computer system that is also coupled to the electronic network and capable of accessing the database system. The first computer system provides a user with access to a first website hosted thereon, and initializes a session for the user. A profile object is created for the user and serialized. The serialized profile object is subsequently stored in the database system with a key. The key can be generated either by the first computer system or by the database system. After the profile object has been stored, the key is transmitted to the second computer system over the electronic network. The second computer system queries the database system in order to access serialized profile objects and retrieve the serialized profile object matching the key. The second computer deserializes the profile object and restores the session at the second website together with the shared session information. This is accomplished without the need to receive authentication information from the user.

There has thus been outlined, rather broadly, the more important features of the invention and several, but not all, embodiments in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These, together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 is a system for sharing session information according to an exemplary embodiment of the present invention;

FIG. 2 is a sample web page illustrating some sample websites that are hosted by external computer systems;

FIG. 3 is a flowchart illustrating the steps performed in sharing session information according to an exemplary embodiment of the present invention;

FIG. 4 is a flowchart illustrating an exemplary procedure for logging users into the system for sharing session information;

FIG. 5 is a block diagram illustrating a computer used for implementing one or more embodiments of the present invention;

FIG. 6 is a block diagram illustrating some of the internal hardware of the computer shown in FIG. 5; and

FIG. 7 is a block diagram of an alternative computer suitable for practicing the present invention.

### DETAILED DESCRIPTION OF THE INVENTION

Reference now will be made in detail to the presently preferred embodiments of the invention. Such embodiments are provided by way of explanation of the invention, which is not intended to be limited thereto. In fact, those of ordinary skill in the art may appreciate upon reading the present specification and viewing the present drawings that various modifications and variations can be made.

For example, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

Prior to describing the details of the invention, a brief discussion of some of the notations and nomenclature used in the description will be presented. Next, a description of exemplary hardware useable in practicing the invention will be presented.

The detailed descriptions which follow may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are preferably machine operations, although the operations may also be manual in alternative embodiments. Useful machines for performing the operation of the present invention include general purpose digital computers or similar devices.

The present invention also relates to apparatus for performing these operations. This apparatus may be specially constructed for the required purpose or it may include a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

The present invention may provide, in part, a system and method for bringing together the vast array of resources available to physicians. Hence, according to one or more embodiments, the invention may provide a content library unmatched in its breadth. It optionally may provide a search engine appropriate for perusing content, such as, Harrison's Online, Cecil's Textbook of Medicine, Praxis.MD, the Merck Manual and many others. In addition, it may provide one or more links to searches such as MD Consult which offer their own extremely comprehensive library. All told, these many resources made accessible via one or more embodiments of the invention may cover primary care and/or any specialty. Optionally, users may utilize a global view or personalize their experience by choosing a specialty view, each of which may appear to be a medical portal in itself. An optional folder feature may allow physicians to, for example, document their visits with extensive bookmarking to track their progress (e.g., previously conducted searches, research links).

The invention optionally includes a comprehensive professional development area, e.g., with board review questions; an optional medical meeting calendar with access to content from many meetings; and optionally the ability to earn/access CME credit through a partner site. The optional patient resource area may exceed that of most physician web portals, and optionally includes access to an immense collection of patient handouts that physicians may easily print. Other resources include coverage of what patients are seeing in the media, color illustrations and easy-to-read descriptions for numerous medical procedures, and resources to help locate clinical trials for patients. Clinical workflow tools optionally include clinical calculators, an ICD-9 search engine, drug interaction checking, and one or more expert systems that assist with antibiotic choices (ThereDoc™) and difficult differential diagnoses (Dxplain™). Optionally, an electronic assistant provides quick links to relevant news and journals, career information and clinical decision support tools that optionally is downloaded to a physician's handheld computer or PDA. A number of unique and powerful features are optionally provided, such as free access to subscription sites (e.g., Harrison's Online, Praxis.MD, MD Consult). Another option is a lectures and presentations builder, allowing users to prepare custom slides for incorporation into, e.g., PowerPoint documents, and including, e.g., public speaking advice.]

One or more aspects of the invention provide access to healthcare and medical resources. The term “resources” used herein is intended to encompass, e.g., information, services, content, applications, and anything else available electronically. According to one or more embodiments of the present invention, medical information resources may include, for example, one or more of reference books and/or databases; several outstanding and/or definitive medical information resources may be accessed electronically, including:

National Library of Medicine databases: MEDLINE, AIDSLINE, Bioethics Line, CANCERLIT,

Harrison's Principles of Medicine,

Dorland's Medical Dictionary,

Physicians' Desk Reference (PDR) and PDR Drug Interaction Database,

Mosby's GenRx, Patient GenRx and Drug Master Plus (drug interaction database),

Merck Manual Online,

Merck Manual Home Edition,

Cecil Textbook of Medicine, and/or

Best Practice of Medicine by Praxis.MD

Optionally, the present invention provides users with the ability to search some of these resources individually or user a search engine to retrieve relevant content from the collection of resources. Simple and/or advanced search capabilities are provided.

Another medical information resource is MD Consult, a collection of medical information resources serving the clinical content needs of physicians and other healthcare providers. This is an example of a resource normally available to physicians by subscription only, but may be provided to registered users of the present invention.

According to one or more embodiments of the present invention, resources may include news, such as available from headlines, abstracts, full journal articles from medical journals, e.g., JAMA, NEJM, Lancet, Annals of Internal Medicine, and/or BMJ. Other news resources may be provided from a newswire service of breaking news stories about medicine, e.g., those that could impact a physician's practice. Resources may also include medical, specialty and/or consumer news. Such articles cover the business of healthcare, consumer medical news, and other health-related news items, and may be obtained from professional and/or lay press resources, e.g., Reuters, FaxWatch, and NewsRX. Optionally, the news directed to the user may be restricted to items of interest to the user, such as matching user registration information.

Another example of medical information resources includes professional development resources and tools, e.g., continuing medical education (CME) information, online CME, a medical meeting calendar with a list of at least major professional conferences, information and/or review modules regarding board review for various therapeutic areas for Board certification and re-certification, links to professional societies, links to government websites, links to medical schools, and/or access to clinical trials information.

Another type of resource relates to patients, e.g., patient education materials such as leaflets, optionally editable/customizable; patient sheets, e.g., printable articles intended for patients to help them better understand their disease and treatment; patient health news, e.g., an archive of health-related news articles in the popular lay press (off line, online, and/or in print); clinical trial information, e.g., a searchable database of clinical trials such as sponsored by NIH and/or industry; links to support groups serving patients, such as in various disease states; and/or a best health guide, having patient education materials and consumer medical news, that may be customizable, printable, and/or e-mailable.

Yet another type of resource relates to practice technology, including for example, health technology news, including news articles and features about technology issues affecting the practice of medicine; evaluations of health technology vendors, e.g., review/comparison of the latest office technology for physician practices, such as billing and scheduling systems and electronic medical records management; interactive technology services, e.g., e-mail questions and answers, as well as FAQs, from a healthcare technology professor; a technology glossary, e.g., a searchable list of technology terms; and/or a practice technology assessment services, to assess a level of technological sophistication in a doctor's practice.

A further type of resource relates to diagnostic assistance, including for example, disease explanations, to help doctors correctly diagnose, based on physician input of clinical information, and providing possible diagnoses, justifications, suggestions for additional clinical information to obtain, and/or list of specific signs/symptoms for a specific disease; practice guidelines providing evidence-based clinical practice guidelines; and/or disease modules, providing overviews of many diseases, e.g., major and/or common disease, including e.g., epidemiology, pathophysiology, diagnosis, and treatment.

Optionally, an electronic folder may be provided for each user, in which the user may organize and store articles, patient materials, and/or links for their convenience and future reference.

Other types of resources include hospital offerings that address the needs of hospital-based audiences (residents, house staff, hospital physicians). Such resources may include, e.g., medical calculators/information, including medical and non-medical information, calculators and content from various sources that are targeted to the needs of residents and medical students; an organizer for medical contents and tables on a PDA to assist users while they work with quick, problem-based solutions to medical questions/clinical issues. Resources intended for hospital physicians include, e.g., reference texts, e.g., culled from core site content as most appropriate for hospital physicians, PDA-downloadable content culled from the core site and customizable by the user; a programmable medical calculator for important clinical calculations.

Other resources include, for example, clinical support tools that provide evidence based therapies and treatments, dosage recommendations, based on patient-specific data; an online ICD-9 Code reference for patient education; PDA software; a web-enabled version of well-respected texts, e.g., Brunwald's Atlas of Internal Medicine, including disease images, charts, and tables, which are optionally downloadable for incorporation into, e.g., medical lectures; and a meeting reporter having news, analysis, posters, and lecture summaries from major medical meetings.

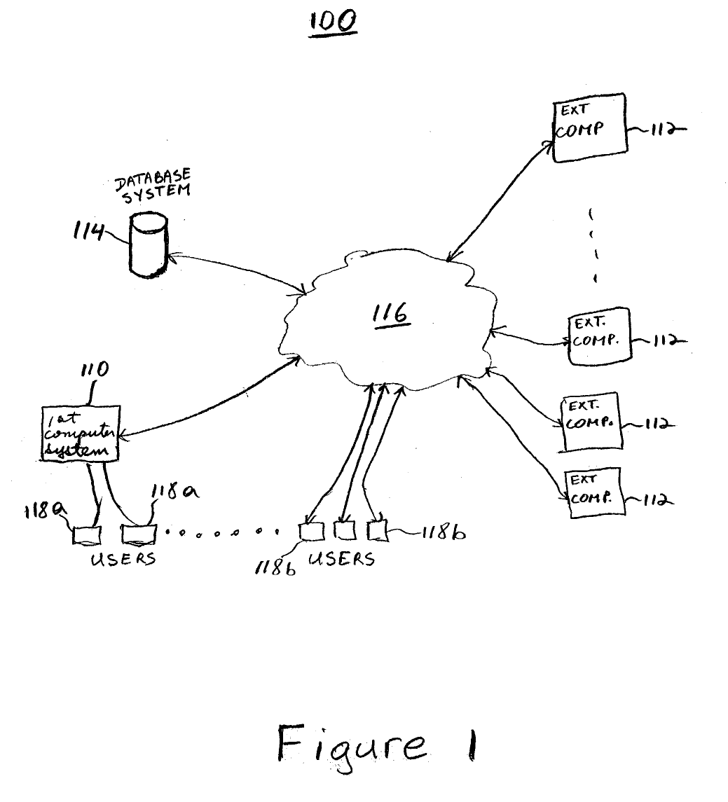

Referring to the drawings, and initially to FIG. 1, an exemplary system 100 for sharing session information according to an exemplary embodiment of the present invention is shown. The system 100 of FIG. 1 includes a first standard computer system 110, a plurality of standard external computer systems 112, and a standard database management system 114. The first computer system 110, the external computer systems 112, and the database system 114 communicate with each other across an electronic network 116 such as the Internet. Furthermore, the first and second computer systems 110, 112 include appropriate hardware and peripherals to facilitate communication across the electronic network 116. Various conventional components of the first and second computer system 110, 112 will be discussed in greater detail herein below with reference to FIGS. 5-7.

According to the disclosed embodiment of the present invention, the first computer system 110 is capable of functioning as a web server which hosts an electronic information system such as, for example, the MerckMedicus™ System. Alternatively, the first computer system 110 can optionally include appropriate hardware for directly connecting to a separate web server. Such an arrangement can be, for example, in the form of a local area network, or can take place over a dedicated high-speed lines across the electronic network illustrated in FIG. 1. The first computer system 110 is also capable of providing simultaneous access to one or more users 118 for browsing through to the contents of the electronic information system. Typically, such users 118b can access, or connect to the first computer system 110 across the electronic network 116. Alternatively, the first computer system 110 can be part of a local area network (LAN) contained, for example, in a medical facility and the users 118a can be medical personnel connected to the LAN.

Regardless of the connection, users 118 accessing the first computer system 110 will periodically require information contained in the external computer systems 112. According to the present invention, the process of retrieving data from external computer systems 112 is greatly simplified by substantially eliminating the need for a user to log into each external website when information must be retrieved. As a user browses through the electronic information system, various pages of information may be retrieved. These pages can sometimes contain information that is stored locally at the first computer system 110. In such occasions, the user would simply access the page without a need to log into the electronic information system. Under certain circumstances, information that is locally stored at the first computer system 110 may require that the user be logged into the system.

When the information displayed to the user is located in one of the external computer systems 112, the user must generally be logged into the electronic information system in order to access the content. During normal operation of the system, a session is created each time a user accesses the first computer system 110. This session can be predefined to persist for a predetermined amount of time after the user has either logged off or become inactive. Additionally, a session object is normally created in order to capture information regarding the user's browsing activities. When a user logs into the system, a profile object is created for that user. The profile object will typically contain all of the users login information and any other personal information that has been entered by the user. When an external computer system 112 must be accessed, the first computer system 110 will serialize the user's profile object and transmit the serialized profile object to the database system 114.

As used herein, serialization refers various object-oriented implementations of a technique to “flatten” objects into a standard binary representation. Such a standard representation was originally developed by Sun Microsystems. For example, when an object is serialized, a description of the object's class is serialized along with it. The class description functions as a template that allows the object to be reconstructed. The class description includes details of the class field names and types. However, numerous variations exist for optimizing the process and/or addressing some of the shortcomings encountered in Sun's implementation.

The serialized profile is then stored with a key, i.e., an encryption key. Thus, in order to subsequently access a particular serialized profile object which has been stored on the database system 114, the proper key must be presented. Once the profile object has been stored, the key is returned to the first computer system 110. According to an optional embodiment of the present invention, the first computer system can generate the encryption key and submit it to the database system 114 together with the serialized profile object. Alternatively, the database system 114 can generate the encryption key.

Once the serialized profile object has been stored in the database system 114 and the key is received by the first computer system 110, the user is redirected to the external computer system 112 which stores the data content (e.g., information or data) to be accessed. The first computer system 110 also transmits the key to the external computer system 112 where the user has been redirected. At the external computer system 112, a new session is initialized for the user. The external computer system queries the database system 114 using the key recently received from the first computer system 110. The database system 114 responds by returning the serialized profile object associated with the key. The external computer system 112 will then proceed to deserialize the profile object and retrieve all of the user information stored therein. The user information is then loaded into memory and used to provide access to the user as if they had manually logged into the external computer system's network and/or website. The page requested by the user is then displayed so that the information can be viewed.

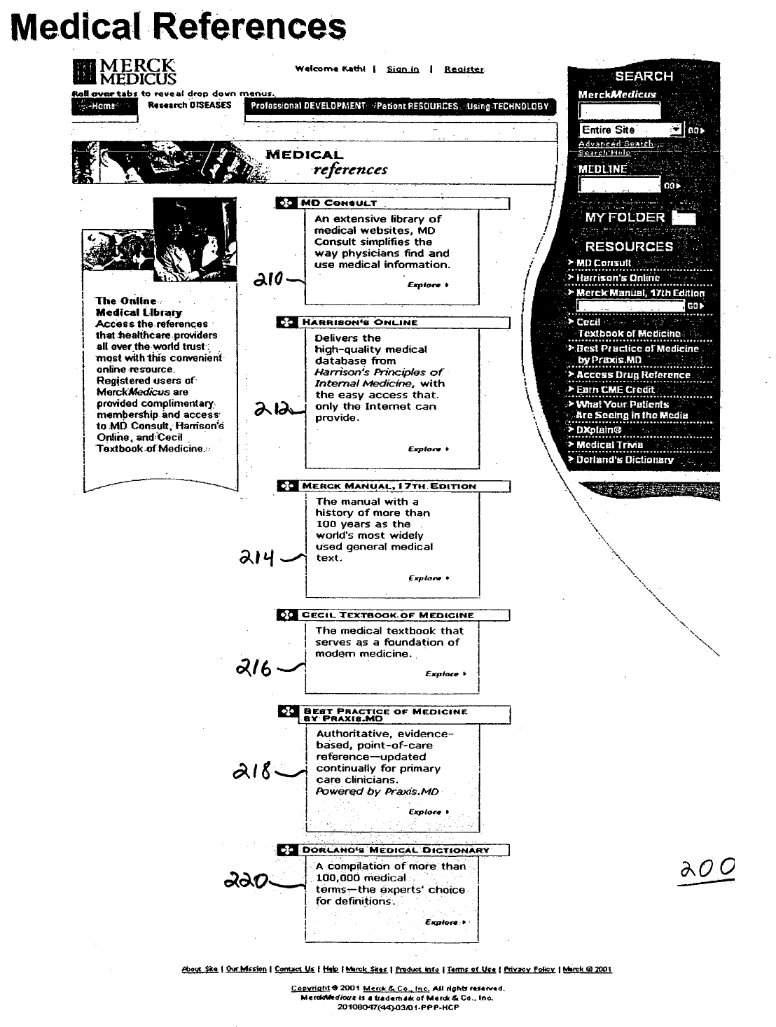

FIG. 2 illustrates an exemplary web page from the first computer system which references some of the information that can be stored on various external computer systems. For example, a user can access the MD Consult database 210 which provides an extensive library of medical websites. Harrison's Online 212 can be accessed in order to retrieve information contained in the reference guide “Harrison's Principles of Internal Medicine.” Similarly the Merck Manual, 17th Edition 214, the Cecil Textbook of Medicine 216, the Best Practice of Medicine by Praxis.MD 218, and Dorland's Medical Dictionary 220 can be accessed online by the user. However, each of these databases are separately owned and operated by different external websites and/or vendors. Thus, the electronic information system merely provides a link, or reference point, from which the user can access information contained in the external computer systems 112. Various other external databases and/or computer systems can be accessed by the user including, but not limited to, scientific journals, conference proceedings, trade publications, etc.

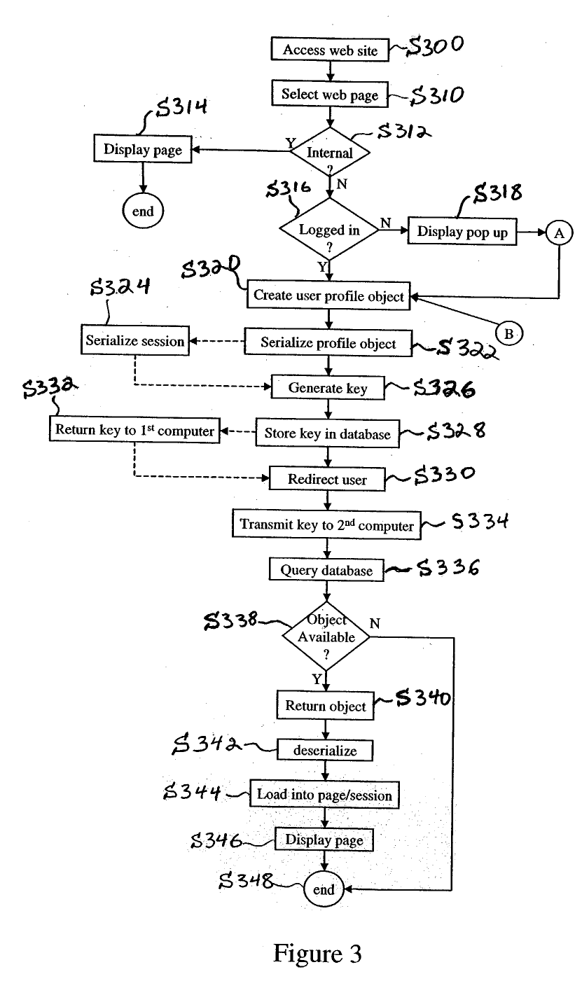

Turning now to FIG. 3, a method for sharing session information according to an exemplary embodiment of the present invention is described. At step S300, the user accesses the electronic information system through the website hosted by the first computer system 110. At this point, the user's session begins. The user is free to browse and visit various web pages during the session. However, in order to access various databases and information content, the user must select a link which will direct them to the web page where the information is housed. This is illustrated at step S310 where the user selects a web page.

At step S312, the first computer system 110 determines if the selected web page is internally housed or externally housed. For example, an internally housed web page could be a database or information content that is stored locally at the first computer system 110. Whereas, a web page which is externally housed contains data that is physically stored on the external computer system 112. If the selected web page is internally housed, then control passes to step S314 where the page is displayed to the user. The process can optionally end or the user can continue browsing. The “end” of the process refers merely to the process of the user accessing the web page or data. This does not necessarily terminate the user's session at the first computer system 110.

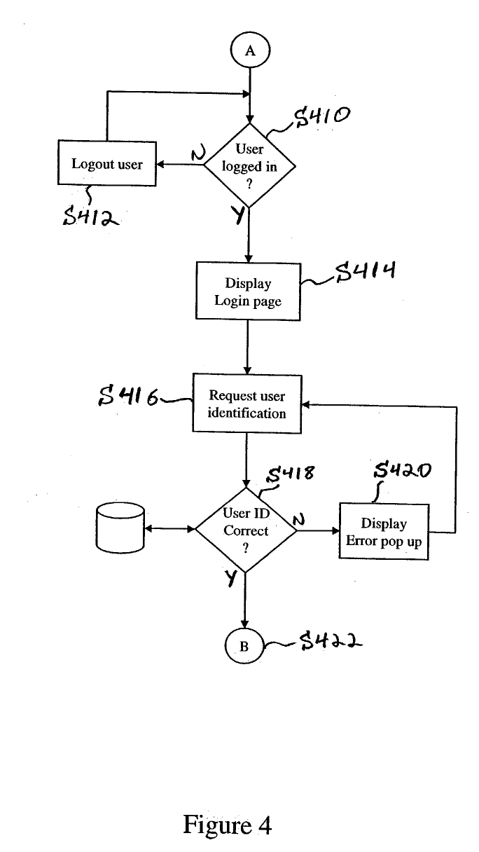

If the web page is externally located, then at step S316 it is determined if the user is logged in. As previously discussed, certain internal web pages can optionally require that the user be logged in prior to granting access. If the user is not logged in, then a pop-up screen is displayed at step S318 to alert the user that they are not currently logged in. The user is then directed to a login screen referenced by control block A in FIG. 3. At the login screen, the user would be prompted to enter the required information for properly logging into the system, as will be described in greater detail with reference to FIG. 4. Once the user has logged in, control would return to step S320 as indicated by control block B. Alternatively, if it is determined at step S316 that the user is already logged in, then a user profile object is created at step S320.

At step S322, the profile object is serialized. According to an optional embodiment of the present invention, rather than serializing the user's profile object, the entire session, with or without the profile object, can be serialized at step S324. At step S326, a key is generated for the serialized profile objective. The serialized profile is stored in the database system 114 together with the key at step S328. As previously discussed, the key can be generated either at the database system or at the first computer system 110. If the key was generated at the database system 114, then at step S332, the key is optionally transmitted or returned to the first computer system 110. Alternatively, if the key was generated at the first computer system 110 then at step S330, the user is redirected to the external computer system 114. At step S334, the key is transmitted to the external computer system 112. At this point, the external computer system 112 would initiate a new session for the user. Using the key, the external computer system 112 would query the database system 114 at step S336 in order to locate the serialized profile object associated with the key.

At step S338, the database system 114 determines if there is a serialized profile object matching the query submitted by the external computer system 112. If there is no profile object matching the query, then the process ends and no serialized profile object is returned. If the profile object is available, then it is returned to the external computer system at step S340. At step S342, the external computer system 112 deserializes the profile object. The data contained in the profile object is loaded into memory, or into the web page which the user wishes to access at step S344. Thus, there is no need for the user to enter additional login, or authentication, information. At step S346, the page requested by the user is displayed. Once the page is displayed, the user is free to browse the external computer system's website and/or submit various queries to retrieve desired information. The process then ends at step S348.

Turning now to FIG. 4, a login procedure is illustrated according to an exemplary embodiment of the present invention. At step S410, it is initially determined if the user is logged into the system. If the user is logged into the system, then control passes to step S412 and the user is logged off the system. This step can be useful for various purposes. For example, the user could have been erroneously determined to be logged into the system. Since the login routine was called after the user was determined to be logged off the system, step S412 ensures that the user again log into the system. Alternatively, a different user may desire access to the system if the computer is a public computer where multiple individuals can access the first computer system 110. Once the user has been logged out at step S412, control returns to step S410 to verify that the user is not logged in. If the user is not logged in, then control passes to step S414 where a login page is presented to the user. The login page will typically require the user to enter a username and a unique password at step S416. The user is then identified based on the user name/password combination. At step S418, the user name and password entered is checked against a password database system. If the user name and password is verified, then control returns to step S320 of FIG. 3 by way of control block B. If the user name and password entered by the user cannot be verified against the password database system, then a pop up screen can be displayed at step S420 to indicate that an error has occurred. The user is redirected to the login screen where they must reenter their user name and password. Control would then proceed to step S416. The process would end at step S422.

It should be understood that the invention is described in connection with logical groupings of functions or resources. One or more of these logical groupings may be omitted from one or more embodiments, and still remain within the scope of the present invention. Likewise, functions may be grouped differently, combined, or augmented without parting from the scope of the invention. Similarly the present description may describe various databases or collections of data and information. One or more groupings of the data or information may be omitted, distributed, combined, or augmented, or provided locally and/or remotely without departing from the scope of the invention.

The user may be a physician or other healthcare professional or student of in the medical field. Some of these users may be licensed for a specific practice, and the licensure may be verifiable. The system may provide the user with expanded online access to high quality healthcare resources. The system may respond to the shifting needs of healthcare professionals, who are constrained to find practical ways to access information and services relevant to their practices, despite their business schedules and geographic constraints. Further, the present invention is intended to provide seamless access to such information.

FIG. 5 is an illustration of a computer 58 used for implementing the computer processing in accordance with a computer-implemented embodiment of the present invention. The procedures described above may be presented in terms of program procedures executed on, for example, a computer or network of computers.

Viewed externally in FIG. 5, computer 58 has a central processing unit (CPU) 68 having disk drives 69, 70. Disk drives 69, 70 are merely symbolic of a number of disk drives that might be accommodated by computer 58. Typically, these might be one or more of the following: a floppy disk drive 69, a hard disk drive (not shown), and a CD ROM or digital video disk, as indicated by the slot at 70. The number and type of drives varies, typically with different computer configurations. Disk drives 69, 70 are, in fact, options, and for space considerations, may be omitted from the computer system used in conjunction with the processes described herein.

Computer 58 also has a display 71 upon which information may be displayed. The display is optional for the computer used in conjunction with the system described herein. A keyboard 72 and/or a pointing device 73, such as a mouse 73, may be provided as input devices to interface with central processing unit 68. To increase input efficiency, keyboard 72 may be supplemented or replaced with a scanner, card reader, or other data input device. The pointing device 73 may be a mouse, touch pad control device, track ball device, or any other type of pointing device.

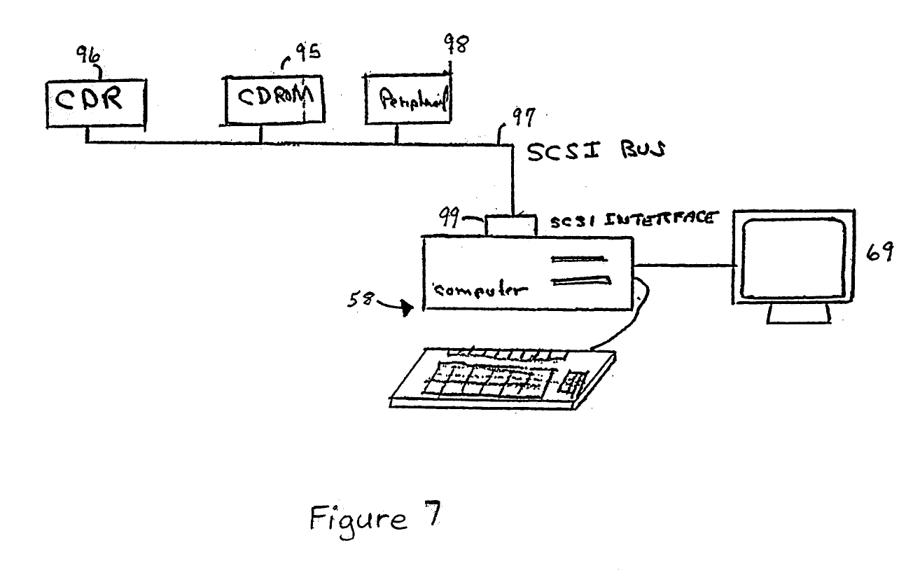

Alternatively, referring to FIG. 7, computer 58 may also include a CD ROM reader 95 and CD recorder 96, which are interconnected by a bus 97 along with other peripheral devices 98 supported by the bus structure and protocol. Bus 97 serves as the main information highway interconnecting other components of the computer. It is connected via an interface 99 to the computer 58.

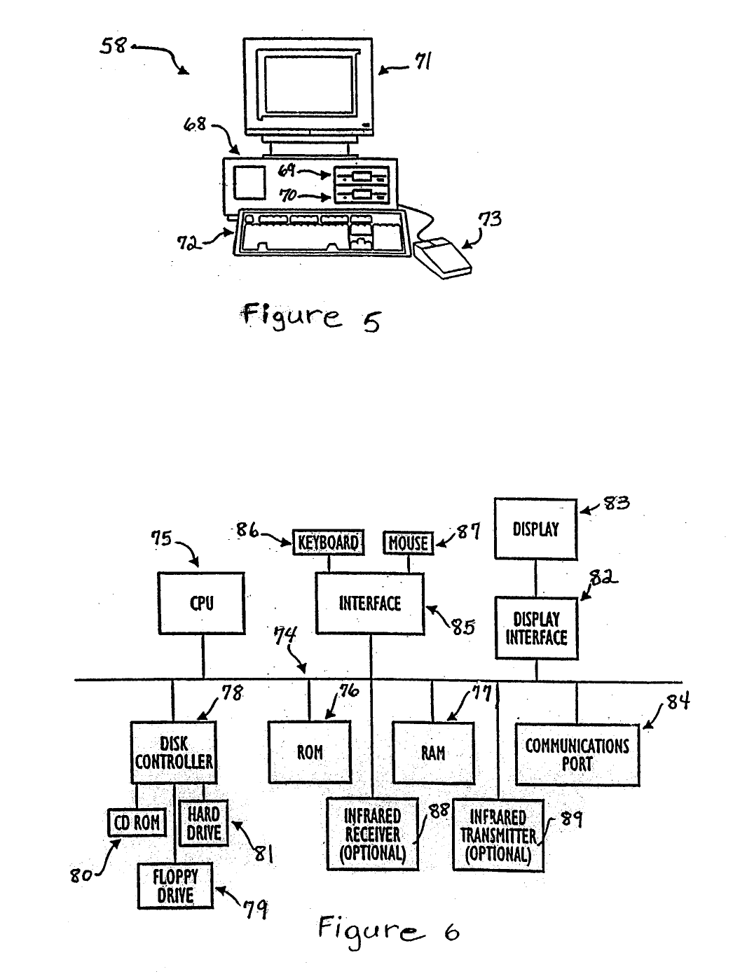

FIG. 6 illustrates a block diagram of the internal hardware of the computer of FIG. 5. CPU 75 is the central processing unit of the system, performing calculations and logic operations required to execute a program. Read only memory (ROM) 76 and random access memory (RAM) 77 constitute the main memory of the computer. Disk controller 78 interfaces one or more disk drives to the system bus 74. These disk drives may be floppy disk drives such as 79, or CD ROM or DVD (digital video/versatile disk) drives, as at 80, or internal or external hard drives 81. As previously indicated these various disk drives and disk controllers are optional devices.

A display interface 82 permits information from bus 74 to be displayed on the display 83. Again, as indicated, the display 83 is an optional accessory for a central or remote computer in the communication network, as are infrared receiver 88 and transmitter 89. Communication with external devices occurs using communications port 84. In addition to the standard components of the computer, the computer may also include an interface 85, which allows for data input through the keyboard 86 or pointing device, such as a mouse 87.

The foregoing detailed description includes many specific details. The inclusion of such detail is for the purpose of illustration only and should not be understood to limit the invention. In addition, features in one embodiment may be combined with features in other embodiments of the invention. Various changes may be made without departing from the scope of the invention as defined in the following claims.

As one example, the system according to the invention may include a general purpose computer, or a specially programmed special purpose computer. The user may interact with the system via e.g., a personal computer or over PDA, e.g., the Internet an Intranet, etc. Either of these may be implemented as a distributed computer system rather than a single computer. Similarly, the communications link may be a dedicated link, a modem over a POTS line, and/or any other method of communicating between computers and/or users. Moreover, the processing could be controlled by a software program on one or more computer systems or processors, or could even be partially or wholly implemented in hardware.

The user interfaces may be developed in connection with an HTML display format. Although HTML is utilized in the illustrated examples, it is possible to utilize alternative technology for displaying information, obtaining user instructions and for providing user interfaces. The invention has been discussed in connection with particular examples. However, the principles apply equally to other examples and/or realizations. Naturally, the relevant data may differ, as appropriate.

Further, this invention has been discussed in certain examples as if it is made available to a single user. The invention may be used by numerous users, if preferred. The system used in connection with the invention may rely on the integration of various components including, as appropriate and/or if desired, hardware and software servers, database engines, and/or other content providers. The configuration may be, preferably, network-based and uses the Internet as a primary interface with the user.

The system according to one or more embodiments of the invention may store collected information and/or indexes to information in a database. An appropriate database may be on a standard server, for example, a small Sun™ Sparc™ or other remote location. The information may, for example, optionally be stored on a platform that may, for example, be UNIX-based. The various databases maybe in, for example, a UNIX format, but other standard data formats may be used.

Although the computer system in FIGS. 5-7 is illustrated as having a single computer, the system according to one or more embodiments of the invention is optionally suitably equipped with a multitude or combination of processors or storage devices. For example, the computer may be replaced by, or combined with, any suitable processing system operative in accordance with the principles of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on floppy disk, provided on CD Rom, provided on optical disk memory, etc.

Any presently available or future developed computer software language and/or hardware components can be employed in such embodiments of the present invention. For example, at least some of the functionality mentioned above could be implemented using Visual Basic, C, C++ or any assembly language appropriate in view of the processor being used. It could also be written in an interpretive environment such as Java and transported to multiple destinations to various users.

Major objectives and advantages of the present invention are convenience and time reduction. Physicians, healthcare personnel, and patients are able to electronically access a wide range of information which includes premium content. The information can be used by physicians and healthcare providers, in part, to improve their respective practices and provide the highest level of care possible. Patients can use this information to about various medical conditions, treatments, drugs, etc. Hence, the patient becomes more informed when discussing their condition. Another important and optional feature of the present invention is the ability to access multiple premium websites without the need to re-enter authentication information. This feature provides an environment where physicians, healthcare providers, and patients are not discouraged from researching and reviewing information.

The present invention alleviates the deficiencies of conventional techniques and systems. The invention enables information provision to physicians and other healthcare providers that is more targeted, more efficient and may be permission-based. The invention provides assistance to physicians in obtaining timely and appropriate information which helps them practice better medicine. The system, according to one or more aspects of the invention, provides the right information in an appropriate format. It also optionally provides for appropriate filtering of information. Importantly, the present invention substantially eliminates the need to continually and repeatedly enter authentication information. The present invention provides a fairly easy way of distributing information targeted to certain physicians, and allowing those physicians to expose themselves more readily to new information. The present invention fosters the best practice of medicine, which creates simultaneous benefits for physicians, and patients.

The present invention optionally brings together a vast collection of resources available to physicians. The invention may provide a content library unmatched in its breadth. It optionally may provide a search engine appropriate for perusing, e.g., Harrison's Online, Cecil's Textbook of Medicine, Praxis.MD, the Merck Manual and many others. In addition, it may provide one or more links to search engines such as MD Consult which offer their own extremely comprehensive library. All told, these many resources may cover primary care and just about every specialty imaginable. Users may utilize a global view or personalize their experience by choosing a specialty view, each of which may be a web portal in itself. The invention may include a comprehensive professional development area with board review questions, a medical meeting calendar with unique content from many meetings and the ability to earn CME credit through a partner site. The patient resource area may exceed that of most physician web portals, and optionally may include access to an immense collection of patient handouts that physicians may easily print. Other resources may include coverage of what patients are seeing in the media, color illustrations and easy-to-read descriptions for numerous medical procedures, and resources to help locate clinical trials for patients. Clinical workflow tools optionally may include clinical calculators, an ICD-9 search engine, drug interaction checking, and expert systems that assist with antibiotic choices (ThereDoc™) and difficult differential diagnoses (Dxplain™). Optionally, an electronic assistant provides quick links to relevant news and journals, career information and clinical decision support tools that may optionally be downloaded to a physician's handheld computer. A number of unique and powerful features may be provided, such as free access to subscription sites (e.g., Harrison's Online, Praxis.MD, MD Consult). Another optional resource is a lectures and presentations builder which allows users to prepare custom slides for incorporation into, e.g., PowerPoint documents, and including, e.g., public speaking advice.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of sharing session information comprising at least on of the sequential, non-sequential and sequential-independent steps:
serializing a session;
generating a key associated with the serialized session;
storing the serialized session and the key associated therewith into a database system;
transmitting the key to a destination where the session information will be shared; and
restoring the session including the shared session information at the destination based, at least in part, on the transmitted key.

2. The method of claim 1, further comprising at least one of the sequential, non-sequential and sequence-independent steps:
receiving information from a user to establish the session; and
authenticating the information received from the user;
wherein the steps of receiving and authenticating are performed prior to the step of serializing.

3. The method of claim 2, wherein the step of receiving information comprises a step of receiving a user ID and password from the user.

4. The method of claim 2, wherein the step of authenticating comprises a step of verifying the received information against a second database system containing user profiles.

5. The method of claim 1, further comprising a step of establishing a session at a first website, prior to performing the step of serializing.

6. The method of claim 5, wherein the destination is a second website unrelated to the first website where the session was established.

7. The method of claim 5, wherein the step of serializing is performed responsive to a user selecting a link which represents information stored at the destination.

8. The method of claim 1, wherein the step of restoring further comprises a step of extracting the serialized session from the database system.

9. A method of sharing session information comprising the steps:
accessing a first website by a user;
serializing a profile object for the user;
storing the serialized profile object in a database system with a key;
forwarding the key to a second website where the session information will be shared;
deserializing the profile object based, at least in part, on the key; and
restoring the session at the second website together with the shared session information.

10. The method of claim 9, further comprising the steps:
selecting a link which identifies information stored on the second website; and
creating a profile object for the user.

11. The method of claim 9, further comprising the steps:
transmitting the key to the first website from the database system; and
redirecting the user to the second website;
wherein the steps of transmitting and redirecting are performed prior to the step of deserializing.

12. The method of claim 9, wherein the step of deserializing further comprises the steps:
creating a new session at the second website;
sending a request for a serialized profile object to the database system together with the key; and
returning the serialized profile object associated with the key to the second website.

13. The method of claim 12, wherein the step of restoring comprises the steps of loading the deserialized profile object into the new session.

14. A method of sharing session information comprising at least one of the sequential, non-sequential and sequence-independent steps:
accessing a first website by a user;
selecting a link which identifies information stored on a second website;
creating a profile object for the user;
serializing the user's profile object;
storing the serialized profile object in a database system with a key;
forwarding the key to the second website;
deserializing the profile object based, at least in part, on the key; and
restoring the session at the second website together with the shared session information.

15. A method of sharing session information comprising at least one of the sequential, non-sequential and sequence-independent steps:
accessing a first website by a user;
serializing a profile object for the user;
storing the serialized profile object in a database system with a key;
transmitting the key to the first website from the database system;
redirecting the user to a second website where the session information will be shared;
forwarding the key to the second website;
deserializing the profile object based, at least in part, on the key; and
restoring the session at the second website together with the shared session information.

16. A method of sharing session information comprising at least one of the sequential, non-sequential and sequence-independent steps:
accessing a first website by a user;
serializing a profile object for the user;
storing the serialized profile object in a database system with a key;
transmitting the key to the first website from the database system;
redirecting the user to a second website where the session information will be shared;
forwarding the key to the second website;
creating a new session at the second website;
sending a request for a serialized profile object;
returning the serialized profile object associated with the key to the second website;
deserializing the profile object based, at least in part, on the key;
loading the deserialized profile object into the new session; and
displaying the web page associated with the link selected by the user together with the shared session information.

17. A method of sharing session information comprising at least one of the sequential, non-sequential and sequence-independent steps:
initializing a session at a first website;
selecting a link which identifies information stored on a second website;
serializing the session at the first website;
generating a key associated with the serialized session;
storing the serialized session and associated key into a database system;
sending the key to the second website where the session information will be shared;
extracting the serialized session from the database system using the received key; and
restoring the session at the second website together with the shared session information.

18. A system for sharing session information comprising:
a database system coupled to an electronic network;
a first computer system coupled to said electronic network and capable of accessing said database system;
said first computer system being configured to:
provide a user with access to a first website hosted thereon, and initializing a session,
create a profile object for the user,
serialize said profile object, and
store said serialized profile object in said database system with a key; and
a second computer system coupled to said electronic network and capable of accessing said database system;
said second computer system being configured to:
receive said key from said first computer system over said electronic network,
query said database system to access profile objects stored thereon,
deserialize the user's profile object based, at least in part, on said received key, and
restore said session at the second website together with shared session information.

19. A system for sharing session information comprising:
a database system coupled to an electronic network, said database system being capable of generating keys for restricting access to data stored thereon;
a first computer system coupled to said electronic network and capable of accessing said database system;
said first computer system being configured to:
provide a user with access to a first website hosted thereon, and initialize a session,
serialize a profile object for the user;
store said serialized profile object in said database system with a key generated by said database system;
receive said key from said database system;
redirect the user to a second website where the session information will be shared; and
a second computer system coupled to said electronic network and capable of accessing said database system, said second computer system hosting said second website;
said second computer system being configured to:
receive said key from said first computer system over said electronic network together with a request to access information contained in a second website stored on said second computer system,
query said database system to access profile objects stored thereon,
deserialize the user's profile object based, at least in part, on said key, and
restore said session at said second website together with the shared session information.

20. A system for sharing session information comprising:
a database system coupled to an electronic network, said database system being capable of generating keys for restricting access to data stored thereon;
a first computer system coupled to said electronic network and capable of accessing said database system;
said first computer system being configured to:
provide a user with access to a first website hosted thereon, and initialize a session,
serialize a profile object for the user,
store said serialized profile object in said database system with a key generated by said database system,
receive said key associated with said serialized profile object from said database system,
redirect the user to a second website where session information will be shared; and
a second computer system coupled to said electronic network and capable of accessing said database system, said second computer system hosting said second website;
said second computer system being configured to:
receive said key from said first computer system over said electronic network together with a request to access information contained in said second website,
query said database system to retrieve said serialized profile object associated with said key,
create a new session on said second website for the user,
deserialize said profile object,
load said deserialized profile object into the new session; and
display the information requested by the user.

21. A system for sharing session information comprising the steps:
a database system coupled to an electronic network, said database system being capable of generating keys for restricting access to data stored thereon;
a first computer system coupled to said electronic network and capable of accessing said database system;
said first computer system being configured to:
provide a user with access to a first website hosted thereon, and initialize a session,
receive a selection of a link, from the user, which identifies information stored on a second website,
serialize the session at said first website,
generate a key associated with said serialized session,
store said serialized session and associated key into said database system,
send said key to said second website where said session information will be shared; and
a second computer system coupled to said electronic network and capable of accessing said database system, said second computer system hosting said second website;
said second computer system being configured to:
receive said key from said first computer system over said electronic network together with a request to access information contained in said second website,
query said database system to extract said serialized session associated with said key; and
restore the session at the second website together with the shared session information.

22. A system for sharing session information comprising:
means for communicating information between multiple locations;
means for providing a user with access to a first website and initializing a session;
means for creating a profile object for the user;
means for serializing said profile object;
means for storing said serialized profile object in a data storage means with a key;
means for receiving said key at a second website over said means for communicating;
means for accessing said data storage means to access profile objects stored thereon;
means for deserializing the user's profile object based, at least in part, on said received key; and
means for restoring said session at the second website together with shared session information.

23. A system for sharing session information comprising the steps:
database means coupled to an electronic network, said database means being capable of generating keys for restricting access to data stored thereon;
means for providing a user with access to a first website using said electronic network and initializing a session;
means for receiving a selection of a link, from the user, which identifies information stored on a second website;
means for serializing the session at said first website;
means for storing said serialized session and associated key into said database means;
means for providing the user with access to said second website and restoring one or mores sessions with shared session information;
means for receiving said key over said electronic network together with a request to access information contained in said second website; and
means for querying said database means to extract said serialized session associated with said key.
